(19) United States
(12) Patent Application Publication
(10) Pub. No.: US 2026/0231882 A1
(43) Pub. Date: Aug. 13, 2026

(54) INDOOR INTERCROPPING SYSTEMS, MODULES AND METHODS THEREOF

(71) Applicant: R.P. GROW-TEC INNOVATIONS LTD., Gazit (IL)

(72) Inventors: Shlomy RAZIEL, Gazit (IL); Ori MINES, Gazit (IL); Nir GALANT, Gazit (IL); Omer PINCHUK, Tel Aviv (IL); Ron AMAR, Shimrit (IL); Ilan HACOHEN, Gadot (IL); Raz BAR-SADE, Gazit (IL)

(21) Appl. No.: 19/154,585

(22) PCT Filed: Feb. 8, 2024
(86) PCT No.: PCT/IL2024/050150

§ 371 Date: Aug. 7, 2025

(30) Foreign Application Priority Data
Feb. 8, 2023 (IL) 300521

(51) Int. Cl. A01G 31/00; A01G 9/24; A01G 31/02; A01G 31/06

(52) U.S. Cl. CPC A01G 31/008; A01G 9/246; A01G 31/025; A01G 31/06

(57) ABSTRACT

An artificially illuminated indoor system for intercropping at least one first crop and at least one second crop comprises an inner volume, enclosed by means of two or more opposite wall portions defining an enveloping vertical inner surface. The first and second crops are cultivated within the inner volume. The first crop is cultivated on tray racks whilst the second crop is cultivated on the enveloping vertical inner surface of the two or more wall portions.

### FIELD OF THE INVENTION

The present invention pertains to an indoor intercropping system, modules and methods for utilizing existing resources in controlled environment growing of at least one second crop for additional growth of at least one second crop. The present invention also related with cost effective indoor systems, modules and synergistic methods for intercropping.

### BACKGROUND OF THE INVENTION

Intercropping agro-systems (aka mixed cropping and polyculture) are a outmoded farming practice with diversified crop cultivation, uses comparatively low inputs and improves the quality of the agro-ecosystem. Todays outdoor intensified intercropping technology ensures enhancement of yield, environmental security, production sustainability and greater ecosystem services. Nevertheless, indoor intercropping cultivation is currently rarely used, see Maitra, Sagar, et al. “Intercropping—A low input agricultural strategy for food and environmental security.” Agronomy 11.2 (2021): 343. One of the reasons is that agricultural systems are dominated by intensive monocultures managed in the context of crop rotations. This is based on the economic perspective of specialization and economies of scale which arises when a producer increases the scale of production, thereby spreading fixed costs over many production units and lowering the per-unit costs of production; see Khanal, Uttam, et al. “Intercropping-evaluating the advantages to broadacre systems.” Agriculture 11.5 (2021): 453.

Fixed (volume independent-) costs of indoor hydroponic or aeroponic intercropping production units are selected from energy consumption of all crops: e.g., light, air conditioning etc., continuous supply of water, fertilizers hormones and biocides, and facility-related costs.

As for light, traditional horticultural illumination systems are based on high pressure Sodium lamps (for growth) or incandescent lamps (for flowering). These have a fixed spectrum and are, mostly, also fixed in terms of light output intensity, see U.S. Ser. No. 10/806,095. Even after LEDs development and commercial use, intercropping of leafy greens with vegetable-like fruits which requires more intensive light is not a common practice due to reduced yields and market prices. Various LED-based techniques were used in intercropping.

WO2019183717, for example, discloses means for illuminating a plant with at least one light beam, the at least one light beam having optical energy within at least two spectral regions each encompassing a given wavelength, the given wavelengths being away from the absorbing wavelengths of the at least one light absorbing pigment, the at least two spectral regions including at least both a first spectral region at about 430 nm and a second spectral region at about 595 nm.

Likewise, U.S. Ser. No. 10/849,279B2 discloses a hydroponic method of growing plants from seeds, where different growth phases are carried out under different photosynthetic photon flux densities and, preferably, under specifically adjusted ratios of red, blue, green, and, optionally, yellow light to one another.

US20140215916A1 discloses plant cultivation method comprising a sequence of irradiating a plant with sunlight; a sequence of irradiating the plant with red light; and a sequence of irradiating the plant with blue light, wherein the sequences are performed independently within a certain period of time.

The photosynthetic photon flux density (PPFD) is the amount of photosynthetically active photons (400-700 nm) hitting a surface per unit area per unit time. The units are μmol of photons m⁻²s⁻¹. WO2012154275A discloses an arrangement configured for a favorable amount of delivered PPFD in a cost-effective manner. For example, by utilizing fewer light bars to optimally illuminate the same number of plants by delivering a desired amount of photons for plants may allow for cost effectiveness in the dollar per delivered photon for plants illuminated Having an optimal amount PPFD for a target area is advantageous as light not delivered to a plant may be wasted. Controlled light areas may ensure that target plants receive the maximum amount of light with minimal wastage, to allow for usage of a fewer lights with an optimal amount of PPFD to reach a plant target area thereby consuming less energy for advantageous lighting. In such a solution, it is required to focus light beam(s) to predefined 2D area. In a 3D vertical cart-based indoor cultivation, such a task is irrelevant or at least not effective, as a light-prolusion is provided.

Those intercropping agro-systems of controllable light, spectra or bean-angle are hence not achievable and does not introduce cost effective solutions. For example, intercropping tomato with various leafy greens, such as marigold, basil and lettuce, demonstrated lower early yields (3, −1 and −7%) and reduced marketable yields (−6, −4 and −7%), respectively, compared to a control (a tomato mono-cultivation): see Tringovska, Ivanka, et al. “Effect of companion plants on tomato greenhouse production.” Scientia Horticulturae 186 (2015): 31-37. It was further concluded that a moderate increase in electrical conductivity from 2.0 to 3.0 dS·m⁻¹ does not exert an important effect on the yield of the grafted tomato or on fruit quality parameters but does cause a decrease in the lettuce yield for both the first and second crops; see da Cunha-Chiamolera, Taniana Pagan Loeiro, et al. “Agronomic and economic feasibility of tomato and lettuce intercropping in a soilless system as a function of the electrical conductivity of the nutrient solution.” HortScience 52.9 (2017): 1195-1200. Similar results obtained by Filho et al., who show that total and commercial cucumber yields were not influenced by the presence of lettuce. Regardless of cropping season, the presence of cucumber affected lettuce: yield, with later transplanting corresponding to greater negative impact, see Filhoet C. al., “Yield of intercropped lettuce and cucumber as a function of population density and cropping season.” Revista Caatinga 32 (2020): 943-951. A recent study shows that intercropping of chicory (Cichorium intybus) and lettuce did not have a beneficial effect on the growth and carotenoid content of chicory; see Ju, Jin-Hee, et al. “Growth and Carotenoid Contents of Intercropped Vegetables in Building-Integrated Urban Agriculture.” Journal of Food Quality 2021 (2021): 1-9.

Much similarly, other fix-cost and variable-costs defining determinators, including e.g., heating, ventilation, and air conditioning (HVAC) and continuous sanitizing of indoor volumes, are shown to hinder indoor hydroponic intercropping cultivating modules. It is hence a long felt need to present cost-effective modules which specifically designed to synergistically reduce fix-cost and variable-costs determinators in indoor hydroponic intercropping systems, and especially in vertical farming thereof.

### BRIEF DESCRIPTION OF THE FIGURES

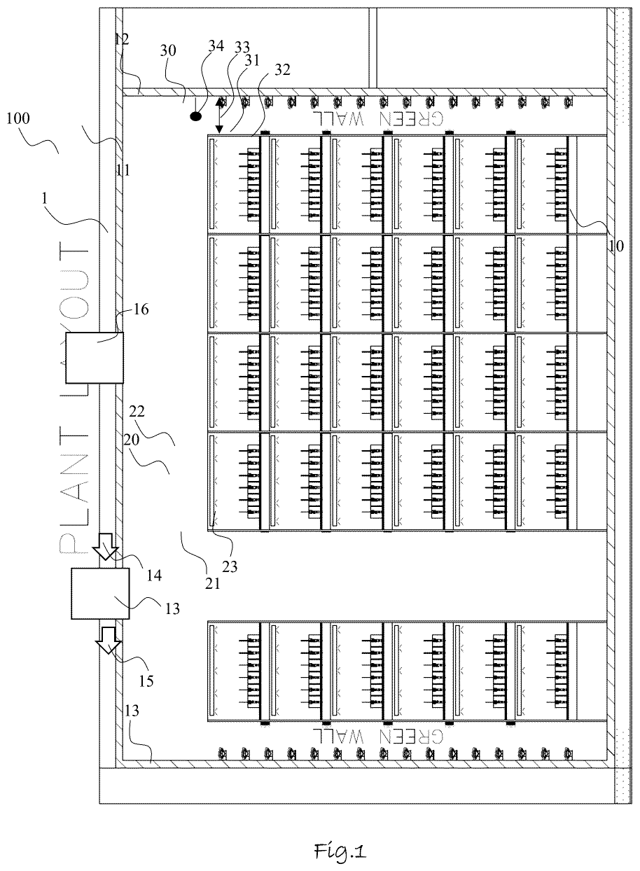

The present invention will become more fully understood from the detailed description and the accompanying drawings, wherein FIGS. 1-3 illustrate in a non-limiting manner methods and indoor system for intercropping, according to various embodiments of the invention.

### SUMMARY OF THE INVENTION

It is an object of the invention to disclose an indoor system for intercropping at least one first crop and at least one second crop. The system comprises, inter alia, an inner volume, enclosed by means of two or more of opposite wall portions defining an enveloping vertical surface. The at least one first crop is cultivated within the inner volume whilst the at least one second crop is cultivated on at least a portion of the enveloping inner surface.

It is another object of the invention to disclose the indoor intercropping system as defined above, wherein the inner portion comprises, or otherwise provided in connection with at least one first set of energy supplies for providing the at least one first crop a sufficient and effective measure of at least one of the following: light; H VAC; and sanitizing. The energy supplies further provide the at least one second crop with a sufficient and effective measure of at least one of the following: light, HVAC and sanitizing.

It is another object of the invention to disclose an indoor intercropping system for utilizing existing resources in controlled environment growing of at least one second crop in addition with the growth of at least one second crop. The inventive step and novelty are in that the at least one first crop is cultivated within the inner volume whilst the at least one second crop is cultivated on at least a portion of the enveloping inner surface. Additionally, or alternatively, the inventive step and novelty are in that the energy supplies of the at least one first crop is providing the at least one second crop with a sufficient and effective measure of at least one of the following: light, HVAC and sanitizing.

It is another object of the invention to disclose the indoor intercropping system as defined in any of the above, wherein the at least one first crop and/or the at least one second crop is/are cultivated in a manner selected from a group consisting of hydroponic horticulture; water farming, vertical farming and any combination thereof. It is another object of the invention to disclose the indoor intercropping system as defined in any of the above, wherein at least one of the following is held true: (a) the at least one first crop is cultivated on at least one first module of trays-rack, or otherwise on at least one first multiple-rack system, each of which is provided within or in connection with the inner volume; and (b) the at least one second crop is cultivated on at least one second module of trays-rack, or otherwise on at least one second multiple-rack system provided adjacent, on- or in connection with at least one portion of the enveloping walls.

It is another object of the invention to disclose the indoor intercropping system as defined in any of the above, wherein the at least one second crop is cultivated on said indoor systems' enveloping inner surface(s) and/or at least one second module of trays-rack, or otherwise on at least one second multiple-rack system provided adjacent, on- or in connection with at least one portion of the enveloping walls.

It is another object of the invention to disclose the indoor intercropping system as defined in any of the above, wherein one or more members of a group consisting the at least one of the tray-rack, multiple-rack system and wall portion are provided with actuating means, such as wheels, cables or rails, so that the distance between a first member of a group to a second can It is another object of the invention to disclose the indoor intercropping system as defined in any of the above, wherein the at least one of the tray-rack, multiple-rack system and wall portion comprises, or otherwise provided in connection with one or more sensors.

It is another object of the invention to disclose the indoor intercropping system as defined in any of the above, wherein the sensor(s) is/are provided useful for detecting at least one parameter selected form a group consisting of distance of a first object to a second one, air temperature, humidity, wet-bulb temp, ΔH, relative humidity, crop's water activity, air flow-speed, air flow direction, air flow volume, electrical conductivity, sound parameters (speed, pressure level, pitch, duration, loudness, timbre and texture), parameters of light and electromagnetic radiation, including intensity, pulses' pattern, continuous wave patterns; additive concentration, weight, including time resolved weight of the rack, the tray and dried crop, photosynthetic photon flux density (PPFD), Photosynthetically active radiation (PAR), photosynthetic photon flux (PPF), Relative growth rate (RGR), Absolute growth rate (AGR) spectra, ‘Leaf Area Ratio’ (LAR), ‘Net Assimilation Rate’ (NAR), Unit Leaf Rate’ (ULR), Specific leaf area (SLA) and Leaf Mass Fraction (LMF), total plant organic Nitrogen (PNC), Root Mass Fraction (RMF), Crop Growth Rate (CGR), Leaf Area Index (LAI), analytics, including chemical, microbial and biological detecting or measuring means, and any combination thereof.

It is another object of the invention to disclose the indoor intercropping system as defined in any of the above, wherein the at least one of the tray-rack, multiple-rack system and wall portion comprises or otherwise provided in connection with at least one second energy supplying module.

It is another object of the invention to disclose the indoor intercropping system as defined in any of the above, wherein the at least one second set of energy supplies consisting an energy supplying module selected from a group consisting of light emitter; HVAC module and sanitizing module, e.g., a commercially available hydrogen peroxide generators and atomization sterilization system, both are available by Suzhou Hjclean Tech Co., LTD (CN); and NTP systems, e.g., those sold by EndRun Technologies Inc (US), and others. Here, the term “NTP” refers to a nonthermal plasma, cold plasma or non-equilibrium plasma which is not in thermodynamic equilibrium, where emitted electron's temperature is hotter than the temperature of heavy species, either ion and neutrals.

It is another object of the invention to discloses the indoor intercropping system as defined in any of the above, wherein the at least one first energy supplies are configured for providing the at least one first crops its particular, sufficient and effective measure of at least one of the following: light; HVAC; and sanitizing. The inventive step and novelty are in that the at least one second energy supplies further configured to provide the at least one second crop its particular sufficient and effective measure of at least one of the following: light: HVAC and sanitizing.

It is another object of the invention to disclose the indoor intercropping system as defined in any of the above, wherein the energy supplying module is in either wirelessly or in cordial communication with a sensor, possibly via a processor.

It is another object of the invention to disclose a method for intercropping at least one first crop and at least one second crop in an indoor system. The method characterized, inter alia, by steps of enclosing an inner volume by two or more of opposite wall portions thereby defining an enveloping vertical inner surface. Another step of cultivating the at least one first crop within the inner volume whilst cultivating the at least one second crop on at least a portion of the enveloping inner surface.

It is another object of the invention to disclose a method for indoor intercropping crops by utilizing existing resources in controlled environment growing of at least one second crop for additional growth of at least one second crop. The inventive step and novelty are in that the at least one first crop is cultivated within the inner volume whilst the at least one second crop is cultivated on at least a portion of the enveloping inner surface.

It is another object of the invention to disclose a method as defined in any of the above, wherein the method further comprising step of providing or otherwise connecting the inner portion with at least one first set of energy supplies, thereby providing the at least one first crop a sufficient and effective measure of at least one of the following: light; HVAC; and sanitizing. The step of ‘providing the at least one first crop’ is useful for further providing the at least one second crop a residual measure of the energy, and that the residual measure is sufficient and effective for the at least one second crop cultivation.

It is another object of the invention to disclose a method as defined in any of the above, wherein the method further comprising step of cultivating the at least one first crop and/or the at least one second crop in a manner selected from a group consisting of hydroponic horticulture; water farming, vertical farming and any combination thereof.

It is another object of the invention to disclose a method as defined in any of the above, wherein at least one of the following is held true: (a) the method is provided useful by cultivating the at least one first crop on a member of a group consisting of at least one first module of trays-rack or otherwise on at least one first multiple-rack system and wall provided within or in connection with the inner volume; and (b) the method is provided useful cultivating the at least one second crop on a member of a group consisting of at least one second module of trays-rack or otherwise on at least one second multiple-rack system and wall portion provided adjacent, on- or in connection with at least one portion of the enveloping walls.

It is another object of the invention to disclose the indoor intercropping method as defined in any of the above, wherein the method comprising a step of providing one or more members of a group consisting the at least one of the tray-rack, multiple-rack system and wall portion are with one or more actuating means, such as wheels, cables or rails, so that the distance between a first member of a group to a second can be changed manually, autonomously or at least semi-automatically.

It is another object of the invention to discloses a method as defined in any of the above, wherein the method further comprising a step of providing at least one of the tray-rack, multiple-rack system and wall portion with a sensor.

It is another object of the invention to disclose a method as defined in any of the above, wherein the method further comprising a step of providing at least one sensor. The sensor is useful for detecting at least one parameter selected form a group consisting of a distance of a first object to a second one, air temperature, humidity, wet-bulb temp, ΔH, relative humidity, crop's water activity, air flow-speed, air flow direction, air flow volume, electrical conductivity, sound parameters (speed, pressure level, pitch, duration, loudness, timbre and texture), parameters of light and electromagnetic radiation, including intensity, spectra, pulses' pattern, continuous wave patterns; additive concentration, weight, including time resolved weight of the rack, the tray and dried crop, PPFD, PAR, PPF, RGR, AGR spectra, LAR, NAR, ULR, SLA and LMF, total PNC, RMF, CGR, LAI, analytics, including chemical, microbial and biological detecting or measuring means, and any combination thereof.

It is another object of the invention to disclose a method as defined in any of the above, wherein the method further comprising a step of providing or otherwise connecting at least one of the tray-rack, multiple-rack system and wall portion with at least one second energy supplying module.

It is another object of the invention to disclose a method as defined in any of the above, wherein the method further comprising step of providing the at least one second set of energy supplies with an energy supplying module selected from a group consisting of light emitter; HVAC module and sanitizing module.

It is another object of the invention to disclose a method as defined in any of the above, wherein the method further comprising steps as follows: (a) configuring the at least one first energy supplies for providing the at least one first crop its particular sufficient and effective measure of at least one of the following: light; HVAC; and sanitizing; and (b) configuring the at least one second energy supplies for providing the at least one second crop its particular sufficient and effective measure of at least one of the following: light; HVAC and sanitizing.

It is another object of the invention to disclose a method as defined in any of the above, wherein the method further comprising step of communicating the energy supplying module with a sensor.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiments set forth herein; rather, this embodiment is provided so that this disclosure will be thorough and complete and will fully convey the scope of the invention to those skilled in the art.

The present invention relates, inter alia, and in a non-limiting manner, to a hydroponic method, system and modules of inter-cultivating co-growing plants such as leafy greens, vegetable-like fruits, other fruits, or flowers in end user environments, such as full-size agricultural facilities, scaled-down control environment agriculture (CEA) facilities, institutional facilities and homes.

CEA allows crops to be grown in a controlled environment designed to maximize the growth of the produce grown in it. Each crop within the farm is planted to ensure it receives the required nutrient, temperature, and humidity best suitable for the maximum yield of the crop. in vertical farming, crops are grown above each other to increase yield per acre. Growing crops in this manner on a piece of land produces ten or more times what is obtainable in traditional farming, where plants are grown horizontally in rows.

The term “indoor” generally refers hereinafter to a land use where the farming of plants takes place indoors. The term also refers any CEA and controlled temperature environment, including an environment created by enclosure in which a desired temperature is maintained by any method known in the art. It in the scope of the invention wherein the term refers in a non-limiting manner to either or both one or more and mixtures or combinations of the following: indoor vertical crop farming, indoor trellising aeroculture, hydroponic crop cultivation, aquaculture, and aquaculture-hydroponic combined farming.

The term “crop” generally refers herein to any plant grown to be harvested, post-harvested or used for any economic purpose, including agriculture crops, aquaculture crops, horticulture crops, floriculture crops, and industrial crops. The term also refers to all plants and plant populations, which includes, desirable and undesirable wild plants, cultivars and plant varieties. Non-limiting examples of crops include crops intended for human or animal consumption (e.g., human food and livestock fodder), for use as clothing (e.g., fiber crops), for use as biofuel (e.g., energy crops, algae fuel), for use in medicine, and for use as decorative, ornamental, or recreational plants. Non-limiting examples of crops intended for human or animal consumption include grain crops such as cereals (e.g., maize, rice, barley, oat, wheat, millet, sorghum, rye) and legumes (e.g., beans, peas, lentils, soybeans), forage crops, fruits and vegetables, tree nuts, and oil, fat and wax crops (e.g., oilseed crops such as canola, sunflower, coconut, palm, rapeseed, peanuts), herbs and medicinal plants such as vanilla pods, lavender, Cannabaceae plants, including cannabis plants and hop plants.

It is in the scope of the invention wherein the crop is selected from a plant grown to be harvested, post-harvested or used for any economic purpose, including agriculture crops, aquaculture crops, horticulture crops, floriculture crops, and industrial crops. It is in the scope of the invention wherein the aforesaid crop is intended for human or animal consumption, including human food and livestock fodder, for use as clothing, including fiber crops, for use as biofuel, including energy crops, algae fuel, for use in medicine, and for use as decorative, ornamental, or recreational plants, grain crops including cereals legumes, forage crops, fruits and vegetables, tree nuts, and oil, fat and wax crops, herbs and medicinal plants, including vanilla pods, lavender, Cannabaceae plants, including cannabis plants and hop plants The term “Cannabaceae plant” is used to include any member of the Cannabaceae family at any stage of development. A “Cannabaceae plant part” refers to any part of a Cannabaceae plant, including a plant cutting, a plant cell, a plant cell culture, a plant organ, a plant seed (achenes), and a plantlet. The family includes at least 170 species grouped in about 11 genera, including economically important genera of Cannabis, Humulus lupulus and Celtis L. species.

The term also broadly refers to include a Cannabis sativa L. plant from any landrace, cultivar, or variety, at any stage of development. A cannabis plant part refers to any part of a cannabis plant, including a plant cutting, a plant cell, a plant cell culture, a plant organ, a plant seed (achenes), and a plantlet. C. sativa L. may be divided into three sub-species: C. sativa ssp. sativa, C. sativa ssp. indica, and C. sativa ssp. ruderalis. The term also refers to all physiologically active substances derived from the cannabis family of plants and synthetic cannabis analogues and derivatives, precursors, metabolites etc., or related substances having cannabis-like physiological effects, including cannabinoid and cannflavins.

As used herein, the term “leafy greens” refers to a crop whose leaves and stems are used as food. This term includes vegetable greens or leafy vegetables such as lettuce (e.g. cutting lettuce, Batavia lettuce, stem lettuce, iceberg lettuce, and roman lettuce), spinach (e.g. baby spinach and New Zealdn spinach), Bok Choy, tatsoi, mizuna, komatsuna, shiso, mangold, and herbs such as rucola (e.g. rocket rock), basil (e.g. vanilla basil, cinnamon basil, lemon basil, red basil, Thai basil, and bush basil), thyme, parsley, mint (e.g. green mint, peppermint, and apple mint), rosemary, coriander, marjoram, oregano, and sage. The term also referring to leafy greens (e.g., lettuce, spinach, kale, Swiss chard, etc.), spices (e.g., saffron, vanilla, mustard, etc.), herbs and microgreens.

As used herein, the term “vegetable-like fruit” refers to a crop that is used like vegetables but botanically are fruits. Non-limiting examples of such plants include tomato, cucumber, vanilla, paprika, and chili pepper. As used herein, the term “plants requiring intensive light” refers to vegetable-like fruit, other fruit and crops, such as medicinal cannabis, which require intensive light for their development, growth, and well-being. The term also referring to crops such as vegetables, including mushrooms, eggplants, squash, peppers, cucumbers, etc.; fruit, e.g., berries, tomatoes, etc.; grains such as rice, wheat, corn, barley, oat, sorghum, rye, quinoa etc., cannabis, medicinal plants, sprouts, and pumpkins.

As used herein, the term “hydroponics” collectively refers to a method of growing plants without soil in a liquid solution of water and nutrients. In soil-less culture, artificial medium may be used to provide mechanical support for the seed to be germinated and any seedling or mature plant developed therefrom. A nutrient film technique (NFT) is a hydroponic technique where in a very shallow stream of water containing all the dissolved nutrients required for plant growth is re-circulated past the bare roots of plants in a watertight gully. The term also refers to aeroponics, namely to systems comprises a nutrient dense mist, i.e., a cloud of moisture containing nutrients with air, is sprayed on to the roots at certain intervals.

The terms “aquaculture” and “water farming” interchangeably refer hereinafter to breeding, growing, and harvesting of animal and crops, such as microorganisms, including mixotrophic, heterotrophic and autotrophic organisms, algae, fish or the like, shellfish and aquatic plants. Intercropping as defined hereto in a non-limiting manner, is a multiple cropping practice that involves growing or otherwise cultivating two or more crops in proximity so that the cropping is provided in parallel along at least one period of time, co-utilizing at least one fix-cost and/or variable-costs defining determinator, including e.g., wetting the air for a predefined relative humidity, lighting, providing HVAC and continuous sanitizing of indoor volumes.

Fixed costs are costs that are independent of volume. Fixed costs tend to be costs that are based on time rather than the quantity produced or sold by your business. Examples of fixed costs are determinators such as rent and lease costs, salaries, utility bills, insurance, and loan repayments.

Some kinds of taxes, like business licenses, are also fixed costs. Since you have to pay fixed costs regardless of how much you sell, you should be careful about adding fixed costs to your small business. Fixed cost is often called overhead. Variable costs are costs that change as the volume changes. Examples of variable costs are determinators such as raw materials, piece-rate labor, production supplies, commissions, delivery costs, packaging supplies, and credit card fees. In some accounting statements, the Variable costs of production are called the “Cost of Goods Sold.”

As used herein, the term “about” refers to an amount that is near the stated amount by 20%, 10%, or 2.5%, including increments therein.

Reference is now made to FIG. 1, schematically illustrating in an out-of-scale manner an indoor cultivating method and a system (100) according to an embodiment of the invention. This system comprises, inter alia, an inner CEA volume (1), enclosed by means of floor 10, ceiling 11, and two or more of opposite wall portions (12, 13) defining an enveloping vertical surface. At least one first crop 23 is cultivated within said inner volume whilst at least one second crop (30) is cultivated on at least a portion of said enveloping surface. The inner portion (1) comprises, or otherwise provided in connection with at least one first set of energy supplies for providing said at least one first crop sufficient and effective measure of at least one of the following: light (22); HVAC (16); and sanitizing (13).

The one or more first crops 23 on one or more first modules of trays-rack (21) or otherwise on one or more first multiple-rack systems (20) provided within or in connection with inner volume 1. Additionally, or alternatively, the one or more second crops 30 on one or more first modules of trays-rack or wall (12) or vertical construction or otherwise on one or more first vertical multiple-rack systems provided within or in connection with inner volume 1.

Indoor intercropping system 100 comprises or otherwise provided in connection with a primary source of light. Hence for example, a least one of the tray-rack 21, multiple-rack system 20 and wall portion 12, 30 may comprises or otherwise provided in connection with at least one first energy supplying module, see line of LEDS 22 for example. Additionally, or alternatively, indoor intercropping system 100 may comprise, or otherwise provided in connection with a secondary source of light 31, e.g., a line of LEDS 31 on, or in connection with shelves rack module 22, configured to emit light towards the second intercropped crop, here, 30, a leafy green mounted on walls 12, 13.

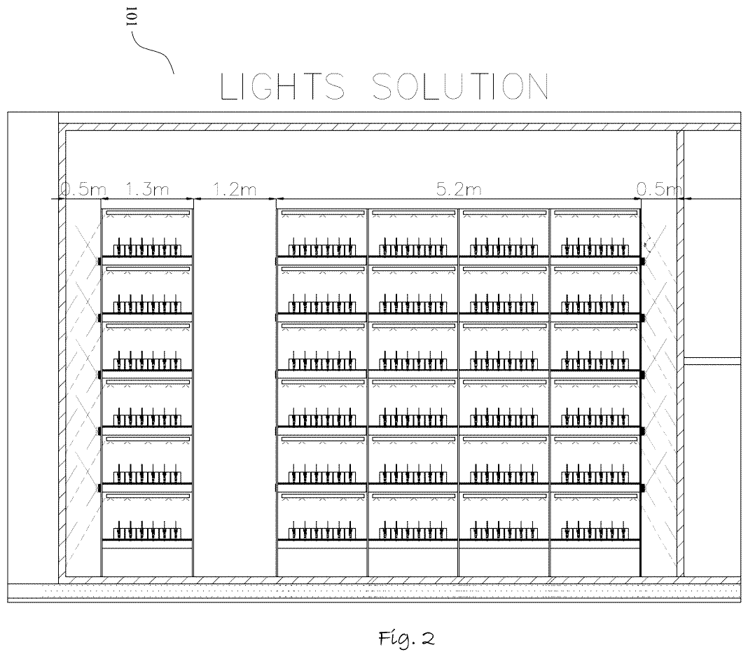

Reference is now made to FIG. 2, schematically illustrating an indoor cultivating method and a system (101) according to an embodiment of the invention. This indoor system is illustrated with its dimensions and proportions in a non-limiting manner.

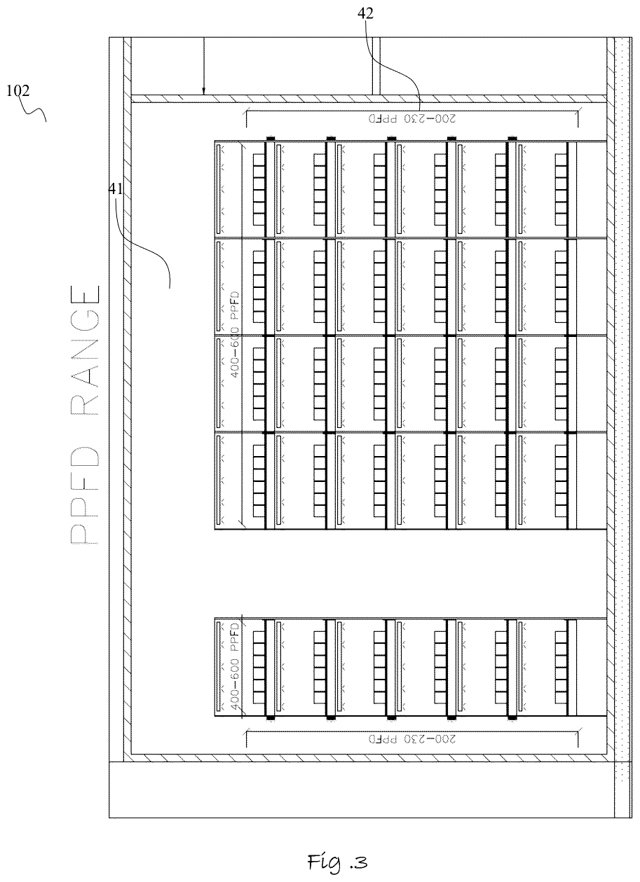

Reference is now made to FIG. 3, schematically illustrating an indoor cultivating method and a system (102) according to an embodiment of the invention. This indoor system is illustrating two or more different light emitters, namely at least one first type of light emitter 41 configured for the cultivation of flowering crops, e.g., PPFD is ranging from 100 to 600 μmol m⁻²s⁻¹; and at least one second type of light emitter 42 configured for the cultivation of leafy greens of a green wall, e.g., PPFD is ranging from 200 to 230 μmol m⁻²s⁻¹.

It is according to an embodiment of the invention wherein data from CEA-sensors are processed and feedback parameters related, e.g., with light emission. Hence for example, moveable racks (such as 20) are utilizable. In this case, light intensity of the additional lighting by light emitter 31, optionally provided in communication with a wall-mounted sensor (34), can be adjusted by adjusting the distance 33 between the green (30) wall (12,13) and the outer surface 32 of a rack on which the additional lighting is installed. The light intensity of the additional lighting is controllable and measurable by sensor.

### Example 1

The Energy Consumption in Lettuce Indoor Growing Traditional Vs. Inter-Cropping Green Wall.

An indoor system as detailed in the figures was found very useful and cost-effective for intercropping at least one first crop (one or more types vegetable-like fruits and/or carrots, green onions/scallions, herbs, hot peppers, potatoes, radishes, cannabis, and vanilla), and at least one second crop (at least one type of a leafy green, and/or basil, lettuce, spinach, arugula, kale, pea shoots etc.). The system comprises an inner volume, enclosed by means of two or more of opposite wall portions defining an enveloping vertical inner surface. Possible measures are indicated as an example in the figures. The at least one first crop (here, a vegetable-like fruit) is cultivated within the inner volume whilst the at least one second crop (here, lettuce) is cultivated on at least a portion of the enveloping inner surface.

The required PPFD by lettuce is ranging from 200 to 220 μmol m⁻²s⁻¹. Measured PPFD on a side wall of a multi-stories horizontal trellising room is ranging from 170 to 220 μmol m⁻²s⁻¹.

The PPFD addition for the less illuminated areas of the wall ranges from 170 to 200 μmol m⁻²s⁻¹. Hence, extra lighting was emitted towards the leafy green in a level ranging from 200-220 μmol m⁻²s⁻¹ by additional LED emitters installed on the shelf closest to the wall. Full scale results suggest that the additional energy may be benefitable for leafy green cultivation as follows: lighting-related savings are 1.5 kwh/kg vs. 6 in traditional indoor growing; and HVAC-related savings: 3.15 kwh/kg vs. 9 in traditional indoor growing. The total is 4.65 kwh/kg vs. total of 15 in traditional indoor growing. This reflects a 69% savings in energy consumption and significant decrease of both fix cost and variable costs.

This example emphasis the effectivity of a method of intercropping a first crop and second crop in an indoor system. The method is characterized by steps of enclosing an inner volume by set(s) of opposite wall portions thereby defining an enveloping vertical inner surface; then cultivating a first crop within the inner volume, whilst cultivating a second crop on at least a portion of the enveloping surface. Optionally, the method further comprises step of providing, or otherwise connecting the inner portion with one or more set(s) of energy supplies, thereby providing the first crops a sufficient and effective measure of at least one of the following: light, HVAC, and sanitizing.

Additionally, or alternatively, those sets of energy supplements to the first crop are useful for providing the second crop a residual measure of the energy, which is sufficient and effective for the cultivation of the crop.

Additionally, or alternatively, those sets of energy supplements the first crop are not enough for providing the second crop a residual measure of the energy, and additional energy, including energy provided by emitting light from, e.g., multi-story shelves. is required for providing sufficient and effective energy supplements to the cultivation of the second crop.

Reference is now made to table 1, underlining the reduction on energy consumption in lettuce indoor growing traditional vs. inter-cropping green wall.

TABLE 1
ENERGY CONSUMPTION OF EXAMPLE 1

| | LED | HVAC | Total | Comments |
|---|---|---|---|---|
| Percentage of total energy | 40% | 60% | | |
| consumption | | | | |
| Energy kwh/kg | 6.00 | 9.00 | 15.00 | |
| Inter-cropping leafy green | 25% | 35% | | The technology disclosed |
| wall energy consumption in | | | | here, clubbed with 3D |
| comparison to traditional | | | | vertical vegetative growing. |
| indoor growing | | | | |
| Inter-cropping green wall | 1.50 | 3.15 | 4.65 | Net energy needed for leafy |
| energy consumption | | | | greens coupled with 3D |
| kWh/kg | | | | vegetative growing |
| Energy saving kwh/kg | −4.50 | −5.85 | −10.35 | |
| | | | −69% | Inter-cropping green wall |
| | | | | Energy saving! |

### Example 2

### Use of White Light for Intercropping Leafy Greens and Vegetable-Like Fruits

Tomatoes (Solanum lycopersicum L cv. Early Girl) are grown in a monochromatic red light produce dryer biomass than those grown in combinations of red and blue lights. However, some studies in lettuce, cucumber, wheat, and rice have indicated that plants have more biomass or higher photosynthetic rate under a combination of red and blue lights compared with monochromatic red light. White light gains several advantages: first, white LED packages are now about 20% of the cost of red LEDs, which has contributed to the increase in the fraction of white LEDs to more than 60% in some horticultural fixtures. Second, compared with red and blue lights, white light creates a more pleasant working environment and enables an easier visual assessment of plant health. Lastly, white light contains useful wide wavebands of spectra other than red and blue lights, such as green light, which can increase photosynthesis and carbon assimilation in the lower parts of the canopy, see Ke, Xinglin, et al. “Optimization of photosynthetic photon flux density and light quality for increasing radiation-use efficiency in dwarf tomato under LED light at the vegetative growth stage.” Plants 11.1 (2021): 121.

The first crop is cultivated on a first module of trays-rack, or otherwise, on a first multiple-rack system provided within or in connection with said inner volume. The second crop is cultivated on a second module of trays-rack, or otherwise, on a second multiple-rack system provided adjacent, on- or in connection with one portion of the enveloping walls.

In some of the intercropping systems, the example provided here is useful wherein one first energy supply is configured for providing a first crop its particular sufficient and effective measure of at least one of the following: light, HVAC, and sanitizing; and wherein a second energy supply is further configured to provide the second crop its particular sufficient and effective measure of at least one of the following: light, HIVAC and sanitizing.

### Example 3

A use of NTP, namely means and methods for electrically energizing and/or ionizing matter in a gaseous state, for decontaminating dried crops of its pathogens is hereto disclosed. NTP was found extremely effective in decontamination of Staphylococcus aureus, Pseudomonas aeruginosa, Escherichia coli and Candida albicans, Aspergillus brasiliensis, Salmonella, Legionella, COVID-19, molds etc. Some relevant data is derived from currently available link: https://www.vsdental.it/uploads/attachment/attachment/433/DOSSIER_scientifico %20JONX_R.03.pdf.

An NTP (13, FIG. 1) was found effective to kill molds in a few minutes by ionizing inflowed air 14 and outflow treated air 15, without requiring to add any additional chemicals. It is acknowledged that the number of NTP units (or their output) is proportional to the room size. Unlike other anti-molds treatments such as UV, in which molds will only be affected if they pass in proximity to the UV bulb, the hereto presented NTP system blows ionized air into the room, creates an atmosphere which neutralizes existing molds and prevents development of new ones. Commercially available NTP and NTP-like means, are commercially available, including, e.g., DUCT™ 70MIC4C product, by Jonix S.p.A. B Corporation (Italy) and Sterionizer™ D6 by FILT AIR Ltd (Israel).

An NTP-based control environment as illustrated in the figures was provided in connection with an array of sensors configured for continuously detecting parameters, as those selected form a group consisting of air temperature, relative humidity, air flow volume, parameters of light emission, and racks' weight. Data from the CEA-sensors were processed and feedbacked one or more of the following: light emission, HVAC operation and NTP-sanitizing parameters, In the specification, there have been disclosed typical preferred embodiments of the disclosure and, although specific terms are employed, they are used in a generic and descriptive sense only and not for purposes of limitation. Some typical embodiments of the disclosure have been described. Many more examples, modifications and variations of the disclosure are possible in light of the above teachings. For instance, although the disclosure and the claims indicate specific steps to perform the invention, the steps described are not limited to a particular sequence of performance and in some circumstances two or more of these steps could be undertaken simultaneously. It is therefore to be understood that within the scope of the appended claims the disclosure may be practiced otherwise than as specifically described, and the scope of the disclosure is set out in the claims.

1.-20. (canceled)

21. An artificially illuminated indoor system for intercropping at least one first crop and at least one second crop, comprising:
an inner volume, completely enclosed by means of a floor, a ceiling, and two or more opposite wall portions defining an enveloping vertical inner surface; said at least one first crop and said at least one second crop are cultivated within said inner volume; said at least one first crop is cultivated on tray racks whilst said at least one second crop is cultivated on said enveloping vertical inner surface of said two or more wall portions; at least one first light supply providing said at least one first crop with an effective amount of light for growth; and
at least one second light supply, light from said at least one first light supply combined with light from said at least one second light supply providing said at least one second crop with an effective amount of light for growth;
wherein said inner volume is completely shielded from solar light.

22. The indoor intercropping system of claim 21, wherein said inner portion comprises, or is otherwise provided in connection with, energy supplies comprising at least one first set of energy supplies for providing said at least one first crop sufficient and effective measure of at least one of the following: light; HVAC; or sanitizing; and wherein said energy supplies further provide said at least one second crop sufficient and effective measure of at least one of the following: light, HVAC or sanitizing.

23. The indoor intercropping system of claim 21, wherein at least one of said at least one first crop or said at least one second crop is cultivated in a manner selected from the group consisting of hydroponic horticulture; water farming, vertical farming or any combination thereof.

24. The indoor intercropping system of claim 21, wherein at least one of the following is true:
a. said at least one first crop is cultivated on at least one first module of tray-racks or otherwise on at least one first multiple-rack system provided within or in connection with said inner volume; or
b. said at least one second crop is cultivated on at least one second module of tray-racks or otherwise on at least one second multiple-rack system provided adjacent to, on, or in connection with at least one portion of said enveloping walls.

25. The indoor intercropping system of claim 24, wherein a member of the group consisting of said at least one first module of tray-racks, said at least one second module of tray-racks, said at least one first multiple-rack system, said at least one second multiple-rack system or said at least one portion of said enveloping walls comprises at least one sensor.

26. The indoor intercropping system of claim 25, wherein said at least one sensor is provided useful for detecting at least one parameter selected from the group consisting of a distance of a first object to a second one, air temperature, humidity, wet-bulb temperature, ΔH, relative humidity, crop water activity, air flow-speed, air flow direction, air flow volume, electrical conductivity, sound speed, sound pressure level, sound pitch, sound duration, sound loudness, sound timbre, sound texture, light intensity, light spectrum, light pulse pattern, light continuous wave pattern, electromagnetic radiation intensity, electromagnetic radiation spectrum, electromagnetic radiation pulse pattern, electromagnetic radiation continuous wave pattern, additive concentration, rack weight, time resolved weight of said rack, time resolved weight of said tray, time resolved weight of dried crop, analytics, PPFD, PAR, PPF, RGR, AGR spectra, LAR, NAR, ULR, SLA, LMF, total PNC, RMF, CGR, LAI, chemical detecting means, chemical measuring means, microbial detecting means, microbial measuring means, biological detecting means, biological measuring means, or any combination thereof.

27. The indoor intercropping system of claim 24, wherein a member of the group consisting of said at least one first module of tray-racks, said at least one second module of tray-racks, said at least one first multiple-rack system, said at least one second multiple-rack system or said at least one portion of said enveloping walls comprises or is otherwise provided in connection with at least one second set of energy supplies.

28. The indoor intercropping system of claim 27, wherein said at least one second set of energy supplies comprises an energy supplying module selected from the group consisting of light emitter; HVAC module or sanitizing module.

29. The indoor intercropping system of claim 28, wherein said energy supplying module is in communication with said at least one sensor.

30. The indoor intercropping system of claim 27, wherein said at least one first set of energy supplies is configured for providing said at least one first crop its particular sufficient and effective measure of at least one of the following: light; HVAC; or sanitizing; and wherein said at least one second set of energy supplies is further configured to provide said at least one second crop its particular sufficient and effective measure of at least one of the following: light; HVAC or sanitizing.

31. A method for intercropping at least one first crop and at least one second crop in an indoor system, said method characterized by steps of:
a. providing a completely enclosed artificially illuminated inner volume comprising a floor, a ceiling, and two or more wall portions defining an enveloping vertical surface;
b. cultivating said at least one first crop and said at least one second crop within said inner volume; said at least one first crop is cultivated on tray racks whilst cultivating said at least one second crop on said enveloping vertical inner surface of said two or more wall portions;
c. illuminating said at least one first crop by at least one first light supply, thereby providing said at least one first crop with an effective amount of light for growth; and
d. illuminating said at least one second crop by at least one second light supply, light from said at least one first light supply combined with light from said at least one second light supply providing said at least one second crop with an effective amount of light for growth;
wherein said inner volume is completely shielded from solar light.

32. The intercropping method of claim 31 further comprising a step of-providing or otherwise connecting said inner portion with at least one first set of energy supplies for providing said at least one first crop sufficient and effective measure of at least one of the following: light; HVAC; or sanitizing; wherein said step of providing said at least one first crop is useful for providing said at least one second crop a residual measure of said energy, said residual measure is sufficient and effective for said at least one second crop cultivation.

33. The intercropping method of claim 31 further comprising step of cultivating at least one of said at least one first crop or said at least one second crop in a manner selected from the group consisting of hydroponic horticulture; water farming, vertical farming or any combination thereof.

34. The intercropping method of claim 31, comprising at least one of the following steps:
a. cultivating said at least one first crop on at least one first module of tray-racks or otherwise on at least one first multiple-rack system provided within or in connection with said inner volume; or
b. cultivating said at least one second crop on at least one second module of tray-racks or otherwise on at least one second multiple-rack system provided adjacent to, on or in connection with at least one portion of said enveloping walls.

35. The intercropping method of claim 34, further comprising a step of providing a member of the group consisting of said at least one first module of tray-racks, said at least one second module of tray-racks, said at least one first multiple-rack system, said at least one second multiple-rack system or said at least one portion of said enveloping walls with at least one sensor.

36. The intercropping method of claim 35, further comprising a step of providing said at least one sensor useful for detecting at least one parameter selected from the group consisting of a distance of a first object to a second one, air temperature, humidity, wet-bulb temperature, ΔH, relative humidity, crop water activity, air flow-speed, air flow direction, air flow volume, electrical conductivity, sound speed, sound pressure level, sound pitch, sound duration, sound loudness, sound timbre, sound texture, light intensity, light spectrum, light pulse pattern, light continuous wave pattern, electromagnetic radiation intensity, electromagnetic radiation spectrum, electromagnetic radiation pulse pattern, electromagnetic radiation continuous wave pattern, including intensity, spectra, pulses' pattern, continuous wave patterns; additive concentration, rack weight, time resolved weight of said rack, time resolved weight of said tray, time resolved weight of dried crop, PPFD, PAR, PPF, RGR, AGR spectra, LAR, NAR, ULR, SLA, LMF, total PNC, RMF, CGR, LAI, analytics, chemical detecting means, chemical measuring means, microbial detecting means, microbial measuring means biological detecting means, biological measuring means, or any combination thereof.

37. The intercropping method of claim 34, further comprising a step of providing or otherwise connecting a member of the group consisting of said at least one first module of tray-racks, said at least one second module of tray-racks, said at least one first multiple-rack system, said at least one second multiple-rack system or said at least one portion of said enveloping walls with at least one second set of energy supplies.

38. The intercropping method of claim 37, further comprising a step of providing said at least one second set of energy supplies with an energy supplying module selected from the group consisting of light emitter; HVAC module or sanitizing module.

39. The intercropping method of claim 38, further comprising a step of communicating said energy supplying module with said at least one sensor.

40. The intercropping method of claim 37, wherein said method comprises steps as follows:
configuring said at least one first set of energy supplies for providing said at least one first crop its particular sufficient and effective measure of at least one of the following: light; HVAC; or sanitizing; and
configuring said at least one second set of energy supplies for providing said at least one second crop its particular sufficient and effective measure of at least one of the following: light; HVAC or sanitizing.
